(19) United States
(12) Patent Application Publication
(10) Pub. No.: US 2019/0225507 A1
(43) Pub. Date: Jul. 25, 2019

(54) SYSTEM AND A METHOD FOR GENERATION AND DELIVERY OF THERMAL ENERGY

(71) Applicant: Rajeev Hiremath, Karnataka (IN)

(72) Inventor: Rajeev Hiremath, Karnataka (IN)

(21) Appl. No.: 16/251,672

(22) Filed: Jan. 18, 2019

(30) Foreign Application Priority Data
Jan. 23, 2018 (IN) 201841002705

(51) Int. Cl. C02F 1/12; C02F 1/04; F28D 15/00

(52) U.S. Cl. CPC C02F 1/12; B01D 1/14; F28D 15/00; C02F 1/043

(57) ABSTRACT

A system for delivery of thermal energy, comprises piping for carrying a pressurized gas, the piping forming a closed loop and having an inlet for receiving the pressurized gas, one or more velocity and pressure enhancers connected along the piping and a heat exchanger connected along the piping. The piping is configured to receive the pressurized gas via the inlet and recirculate the pressurized gas inside the closed loop. The one or more velocity and pressure enhancers are configured to maintain flow, velocity and thermal energy of the pressurized gas to predetermined values of the flow, the velocity and the thermal energy, inside the closed loop. Also, the heat exchanger is configured to transfer at least a part of the thermal energy of the pressurized gas to a process application.

### CROSS REFERENCE TO RELATED APPLICATIONS

The present application is a Convention Application taking priority under 35 U.S.C. 119 from Indian Patent Application No. 201841002705, filed on Jan. 23, 2018, the contents of which are incorporated herein by reference.

### TECHNICAL FIELD

The present invention relates to delivery of thermal energy in system(s) utilizing kinetic energy of a working fluid. More specifically the invention relates to a system and a method for delivery of thermal energy, through a heat exchanger, by utilizing high flow and velocity of the working fluid for achieving very high heat transfer rates, thereby reducing volumes and footprints of the system and the method, with minimum temperature difference across the heat transfer mediums.

### BACKGROUND ART

Process heating is an important aspect of manufacturing, commercial and domestic sectors and contributes to a significant share of a total energy consumption. The process heating may be applied to several applications such as, but not limited to, heating, drying, curing, and phase change of a variety of materials in industries producing products made up of metal, glass, polymers, concrete and ceramics etc. and other industries such as waste water treatment, desalination, food processing, district heating and cooling applications, cooking and domestic heat energy requirements. In the present state of the art, the process heating technologies are designed around a limited number of energy sources. These sources typically include use of carbonaceous fuels, electricity, superheated and pressurized steam and combinations thereof (also known as hybrid sources).

The carbonaceous fuels generally include bio-fuels, coal, oil and natural gas, and in some cases, may include extracts or derivates of the fossil fuels, such as coke, coal slurry, and by products obtained after industrial processes. However, in any case, the combustion of fossil fuels is known to cause severe damage to the environment, especially due to release of toxic or otherwise harmful exhaust emissions, such as COₓ, NOₓ and particulate matter. Moreover, the present-day development philosophy is rapidly shifting away from use of fossil fuels and towards reducing of carbon footprint on the environment.

Electricity may be used in both direct and indirect heating applications. Known technologies involving use of electricity for process heating include electric arc furnaces, infrared emitters, induction heating, radio frequency drying, laser heating and microwave processing. While on the face of it electricity may seem to provide a comparatively cleaner alternative to combustion of fossil fuels, the implementation of the aforesaid technologies is impeded due to excessive operational expenditure and relatively lower efficiencies in heat transfer.

The use of pressurized and superheated steam does seem to offer a low-cost alternative, in a manner that the steam may be produced by combustion of relatively low-cost fuels (including industrial by products). However, the available technologies are limited to relatively very low temperature applications (typically 500° C.). Moreover, steam generation would in turn require combustion of fossil fuels, again giving rise to harmful emissions.

Hybrid process heating sources aim to address the trade-offs that exist in the aforesaid sources and technologies. However, the technologies involved in utilization of hybrid sources (such as a combination of a fuel-based boiler and an electric based boiler or a combination of electromagnetic energy and convective hot air) are associated with increased capital expenditure due to complexities involved in combining two or more technologies.

Several attempts have been made in recent years to address the aforementioned deficiencies and some of the noteworthy ones include development of relatively cleaner and more efficient flame based combustion devices, development of non-burner type combustion systems (such as catalytic combustion), development of sensors and control systems for better monitoring and control of process heating, use of heat recovery devices such as self-recuperative burners and application of combined heat and power (CHP). However, these attempts too have suffered from several impediments. For example, the new flame-based combustion devices are not applicable to all the available industrial heat generating equipment and designs and therefore address the deficiencies in a very limited scope. Moreover, all the recent attempts have largely been incremental improvements, while the energy demands for the process heating applications are continuously increasing at a much rapid rate for the incremental improvements to catch up to.

Moreover, present day heat transfer systems need to operate with significantly large volumes or area requirements for heat transfer, because of relatively low pressures and velocities of the working fluids involved. Therefore, the present scenario needs a more disruptive approach to address the issues and deficiencies associated with the present-day process heating technologies.

Therefore, in light of the above discussion, there is a need in the art for a system and a method for delivery of thermal energy, that does not suffer from above mentioned deficiencies.

### SUMMARY OF THE INVENTION

The present invention is described hereinafter by various embodiments. This invention may, however, be embodied in many different forms and should not be construed as limited to the embodiment set forth herein. Rather, the embodiment is provided so that this disclosure will be thorough and complete and will fully convey the scope of the invention to those skilled in the art.

Embodiments of the present invention aim to provide a system and a method for delivery of thermal energy that allows generation of pressure and velocity along with increased mass flow rate while consuming less energy.

According to a first aspect of the present invention, there is provided a system for delivery of thermal energy, the system comprising piping for carrying a pressurized gas, the piping forming a closed loop and having an inlet for receiving the pressurized gas, one or more velocity and pressure enhancers connected along the piping and a heat exchanger connected along the piping. The piping is configured to receive the pressurized gas via the inlet and recirculate the pressurized gas inside the closed loop. The one or more velocity and pressure enhancers are configured to maintain flow, velocity and thermal energy of the pressurized gas to predetermined values of the flow, the velocity and the thermal energy, inside the closed loop. Also, the heat exchanger is configured to transfer at least a part of the thermal energy of the pressurized gas to a process application.

In accordance with an embodiment of the present invention, the pressurized gas includes one or more of air, CO₂, N₂ and O₂.

In accordance with an embodiment of the present invention, the system further comprises a valve configured to control flow of the pressurized gas into the piping.

In accordance with an embodiment of the present invention, the piping includes an insulation provided along the piping.

In accordance with an embodiment of the present invention, the one or more velocity and pressure enhancers are configured to be operated using variable frequency and/or variable speed drives.

In accordance with an embodiment of the present invention, the heat exchanger is a direct contact type heat exchanger.

In accordance with an embodiment of the present invention, the system further comprises one or more of an inline filtering system and a condenser connected along the piping.

In accordance with an embodiment of the present invention, the system further comprises one or more nozzles provided along the closed loop, wherein the one or more nozzles are configured to enhance the velocity of the pressurized gas in the piping.

In accordance with an embodiment of the present invention, the system further comprises a plurality of pressure sensors configured for monitoring and control of the pressure inside the closed loop, a plurality of temperature sensors configured for monitoring and control of the temperature of the pressurized gas, a plurality of velocity sensors configured for monitoring of the velocity and the mass flow rate of the pressurized gas and a central control system connected with the plurality of pressure sensors, the plurality of temperature sensors and a plurality of velocity sensors.

In accordance with an embodiment of the present invention, the system further comprises a heat source provided along the piping, wherein the heat source is configured to provide concentrated thermal energy to the pressurized gas.

In accordance with an embodiment of the present invention, the system further comprises a plurality of flow control valves provided along the piping, wherein the plurality of flow control valves is configured to isolate a section of the piping, the isolated section having a lower pressure as compared to rest of the piping.

In accordance with an embodiment of the present invention, the piping has a variable cross-section area.

In accordance with an embodiment of the present invention, the system further comprises a turbomachinery assembly with a Power Take-Off (PTO) shaft, connected along the piping.

According to a second aspect of the present invention, there is provided a heat exchanger for water treatment applications, the heat exchanger comprising a vessel including a working fluid inlet configured to receive a working fluid into the vessel through one or more flow directing nozzles and a feed water inlet configured to receive feed water, a plurality of spray nozzles provided with the feed water inlet, the plurality of spray nozzles configured to atomize and spray the feed water into the vessel, a fluid outlet configured to discharge a fluid mixture of vaporized feed water and the working fluid, formed due to vaporization of the atomized feed water on coming in contact with the working fluid and a solid outlet configured to remove solids separated due to vaporization of the feed water.

According to a third aspect of the present invention, there is a system for delivery of thermal energy, the system comprising piping for carrying a pressurized gas, the piping forming an open loop and having an inlet for receiving the pressurized gas, one or more velocity and pressure enhancers connected along the piping and a heat exchanger connected along the piping. The piping is configured to receive the pressurized gas via the inlet. The one or more velocity and pressure enhancers are configured to maintain flow, velocity and thermal energy of the pressurized gas to predetermined values of the flow, the velocity and the thermal energy, inside the open loop. Also, the heat exchanger is configured to transfer at least a part of the thermal energy of the pressurized gas to a process application.

In accordance with an embodiment of the present invention, the system further comprises a heat source provided along the piping, wherein the heat source is configured to provide concentrated thermal energy to the pressurized gas.

According to a fourth aspect of the present invention, a method for delivery of thermal energy, the method comprising steps of receiving a pressurized gas into piping, via an inlet, the piping forming a closed loop and recirculating the pressurized gas inside the closed loop, maintaining flow, velocity and thermal energy of the pressurized gas to predetermined values of the flow, the velocity and the thermal energy, inside the closed loop, through one or more velocity and pressure enhancers and transferring at least a part of the thermal energy of the pressurized gas to a process application, through a heat exchanger.

In accordance with an embodiment of the present invention, the method further comprises a step of providing thermal energy to the pressurized gas, through a heat source.

In accordance with an embodiment of the present invention, the method further comprises a step of enhancing the velocity of the pressurized gas in the piping, through one or more nozzles.

According a to fifth aspect of the present invention, there is provided a method for delivery of thermal energy, the method comprising steps of receiving a pressurized gas into piping, via an inlet, the piping forming an open loop, maintaining flow, velocity and thermal energy of the pressurized gas to predetermined values of the flow, the velocity and the thermal energy, inside the open loop, through one or more velocity and pressure enhancers and transferring at least a part of the thermal energy of the pressurized gas to a process application, through a heat exchanger.

The system and the method for delivery of thermal energy offer several advantages, viz.,

1. Temperature of the working fluid may be maintained very close to the process application temperature. Moreover, the temperature drop across the heat exchanger would be relatively minimal as compared to the prior art. This makes the invention highly applicable to process applications where a strict control of source temperature is required.

2. Since we are using the working fluid at relatively lower temperatures, the working fluid will have a higher density for a given pressure value and higher velocity. This leads to higher mass flow rates because of comparatively higher density and velocity, thereby contributing to increased rate of heat transfer from the working fluid to the process application, in a given area.

3. Due to increase in the density and the velocity of the working fluid, the volumetric flow rate required for a particular rate of heat transfer will be reduced and thereby reducing the system volume and higher velocity would bring down the heat transfer area of the heat exchanger. Higher densities and velocities would also be advantageous in scenarios where working fluid takes up heat from heat sources.

4. Temperature of the working fluid may be raised to levels comparable to that achieved through combustion of fossil fuels, without combusting any fossil fuel. This allows the process fluid whether air, CO₂, N₂ or any other gases and combinations thereof, to attain very high temperatures without oxidation.

5. High efficiency, no carbon footprint, less stringent material of construction and low carbon footprint.

6. No heat is lost to the ambient because of the recirculation of the working fluid inside the closed loop.

7. Densities of combusted gases or pressurized steam currently being used as the heat transfer media, do not have high density and velocity, whereas the working fluid of the present invention, can be configured to have very high densities and high velocities so as to achieve faster rates of heat transfer.

8. With increased efficiencies of the heat source, in transferring heat to the working fluid, operational costs will be reduced compared to the state of the art.

### BRIEF DESCRIPTION OF THE ACCOMPANYING DRAWINGS

So that the manner in which the above recited features of the present invention can be understood in detail, a more particular description of the invention, briefly summarized above, may have been referred by examples, some of which are illustrated in the appended drawings. It is to be noted, however, that the appended drawing illustrates only typical examples of this invention and are therefore not to be considered limiting of its scope, for the invention may admit to other equally effective examples.

These and other features, benefits, and advantages of the present invention will become apparent by reference to the following text figure, with like reference numbers referring to like structures across the views, wherein:

FIG. 1A illustrates a system for delivery of thermal energy, in accordance with an embodiment of the present invention;

FIG. 1B illustrates a system for delivery of thermal energy, in accordance with another embodiment of the present invention;

FIG. 1C illustrates a system for delivery of thermal energy, in accordance with yet another embodiment of the present invention;

FIG. 1D illustrates a system for delivery of thermal energy, in accordance with yet another embodiment of the present invention;

FIG. 2 illustrates a method for delivery of thermal energy, in accordance with yet another embodiment of the present invention;

FIG. 3A illustrates an application of the system for delivery of thermal energy, for heating of a process fluid, in accordance with an embodiment of the present invention;

FIG. 3B illustrates an application of the system for delivery of thermal energy, for heating of a process fluid, in accordance with another embodiment of the present invention;

FIG. 4 illustrates an application of the system for delivery of thermal energy, for direct heating of process substances, in accordance with an embodiment of the present invention;

FIG. 5 illustrates an application of the system for delivery of thermal energy, for Combined Heating and Power (CHP) applications, in accordance with an embodiment of the present invention;

FIG. 6A illustrates an application of the system for delivery of thermal energy, for water treatment, in accordance with an embodiment of the present invention;

FIG. 6B illustrates a heat exchanger, for water treatment, in accordance with an embodiment of the present invention;

FIG. 6C illustrates a condenser for water treatment applications, in accordance with an embodiment of the present invention;

FIG. 6D illustrates an application of the system for delivery of thermal energy, for water treatment, in accordance with another embodiment of the present invention;

FIG. 7A illustrates a system for delivery of thermal energy, employing an open loop cycle, in accordance with an embodiment of the present invention; and

FIG. 7B illustrates a method for delivery of thermal energy, employing an open loop cycle, in accordance with an embodiment of the present invention.

### DETAILED DESCRIPTION OF THE PREFERRED EMBODIMENTS

While the present invention is described herein by way of example using embodiments and illustrative drawings, those skilled in the art will recognize that the invention is not limited to the embodiments of drawing or drawings described and are not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed, but on the contrary, the invention is to cover all modifications, equivalents, and alternatives falling within the scope of the present invention as defined by the appended claim. As used throughout this description, the word “may” is used in a permissive sense (i.e. meaning having the potential to), rather than the mandatory sense, (i.e. meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes. Any discussion of documents, acts, materials, devices, articles and the like are included in the specification solely for the purpose of providing a context for the present invention. It is not suggested or represented that any or all of these matters form part of the prior art base or were common general knowledge in the field relevant to the present invention.

In this disclosure, whenever a composition or an element or a group of elements is preceded with the transitional phrase “comprising”, it is understood that we also contemplate the same composition, element or group of elements with transitional phrases “consisting of”, “consisting”, “selected from the group of consisting of”, “including”, or “is” preceding the recitation of the composition, element or group of elements and vice versa.

The present invention is described hereinafter by various embodiments with reference to the accompanying drawing, wherein reference numerals used in the accompanying drawing correspond to the like elements throughout the description. This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only and are not intended to limit the scope of the claims. In addition, a number of materials are identified as suitable for various facets of the implementations. These materials are to be treated as exemplary and are not intended to limit the scope of the invention.

Introduction of the pressurized gases into, a closed loop system, in sufficiently high quantities gives rise to a very high-density gas. This leads to higher mass flow rates because of comparatively higher density and velocity, thereby contributing to increased rate of heat transfer from the working fluid to the process application, in a given area. Due to increase in the density and the velocity of the working fluid, the volumetric flow rate required for a particular rate of heat transfer will be reduced and thereby reducing the system volume and higher velocity would bring down the heat transfer area of the heat exchanger. Higher densities and velocities would also be advantageous in scenarios where working fluid takes up heat from heat sources, as higher densities resulting from higher pressure of the working fluid will allow larger amounts of heat energy to be packed into a given volume, as compared to the working fluid being at ambient conditions. Consequently, for certain applications, temperature of the working fluid may be raised to levels comparable to that achieved through combustion of fossil fuels, without combusting any fossil fuel.

The present invention offers a system and a method for delivery of thermal energy, that are designed as explained above, in such a way that minimum drop in temperature is achieved across a heat exchanger, by adjusting mass flow rate of the pressurized gas as a working fluid. The velocity is generated with the help of velocity and pressure enhancers, along with nozzles provided along a closed loop, in the range of subsonic speeds to up to supersonic speeds for the given pressure values. In the context of this specification, the term “pressurized gas” refers to a gaseous fluid at above ambient pressures.

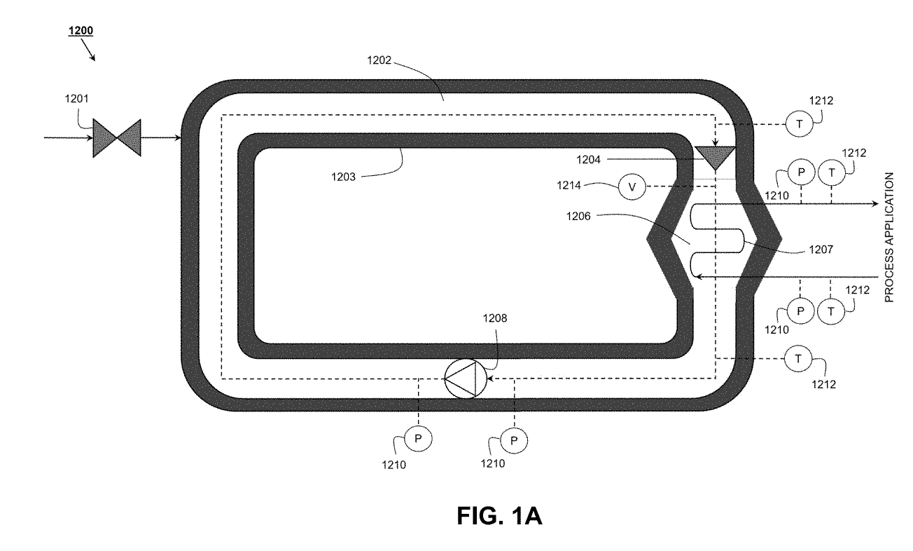

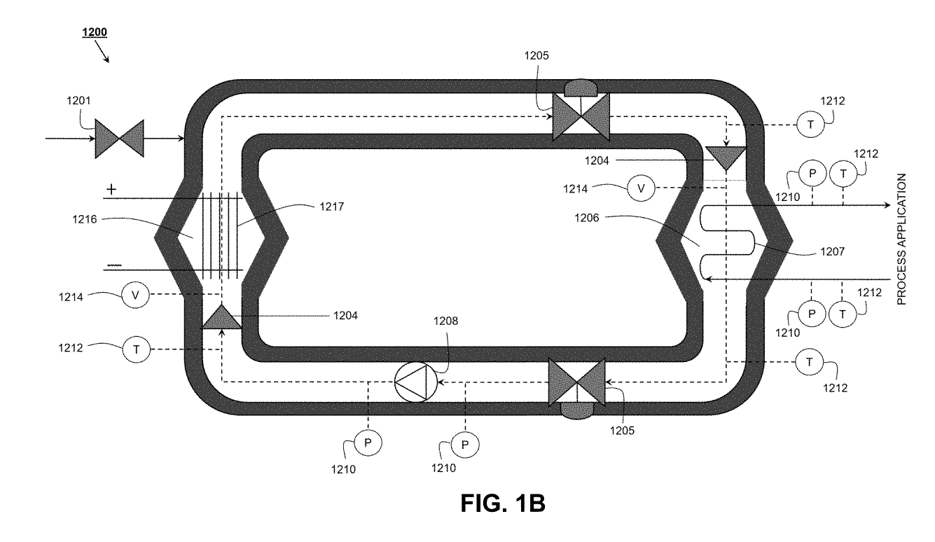

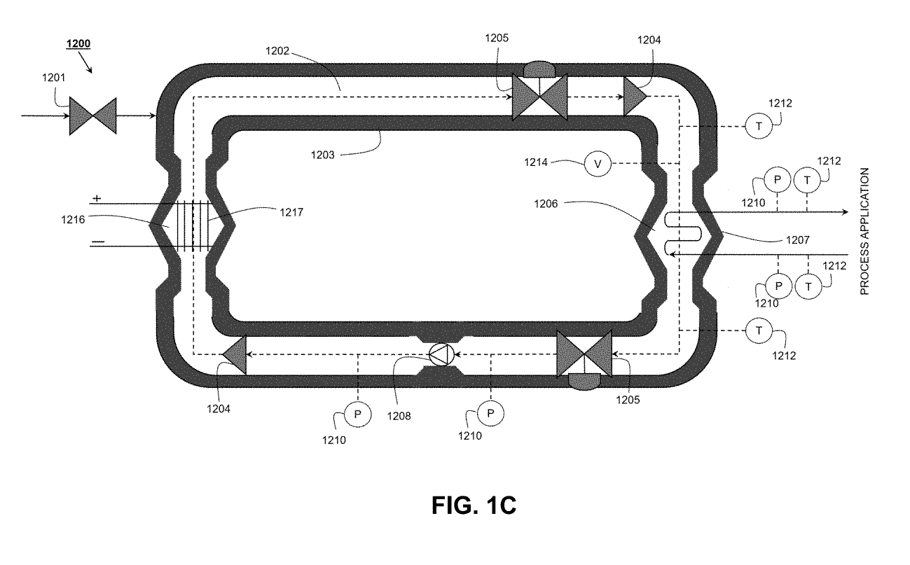

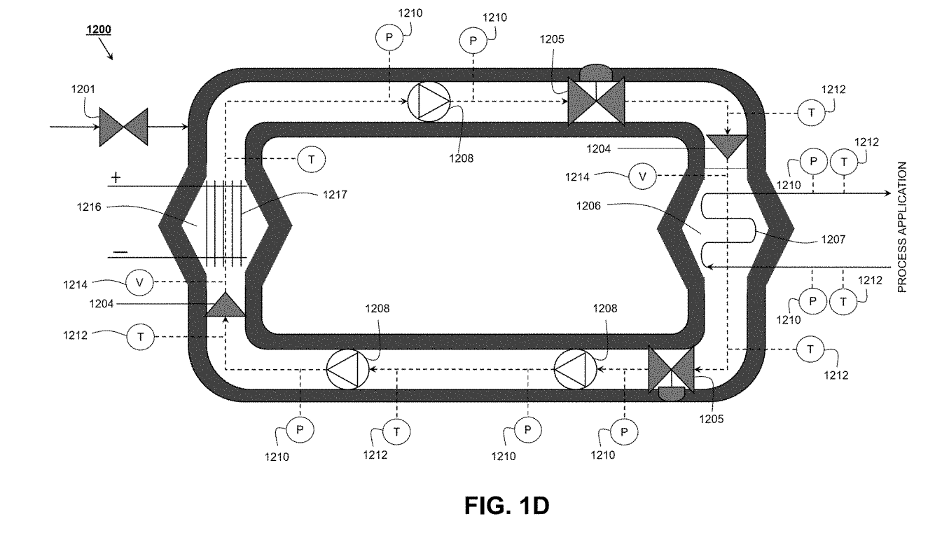

Referring to the drawings, the invention will now be described in more detail. FIG. 1A illustrates a system 1200 for delivery of thermal energy, in accordance with an embodiment of the present invention. The system 1200 comprises piping 1202 for carrying a pressurized gas. Typical delivery pressures of the pressurized gas would vary between ambient and up to 500 bars and above, depending upon operating temperatures. In the context of the specification, the word “piping” is envisaged to include all kinds of conduits required for circulation of fluids at predetermined temperatures, pressures and velocity. For example, for fluids at relatively lower temperatures but higher pressures and velocities, the piping could be made up of a metal. For fluid at relatively higher temperatures and velocities, but lower pressures, the piping may be construed either as metallic piping with refractory lining or ducting made up of a refractory material or combinations of the above are also possible. A skilled addressee would appreciate that many other variations for the piping are possible without departing from the scope of the invention.

The pressurized gas can be for example, but is not limited to, air, CO₂, N₂ and O₂ etc. As can be seen from FIG. 1A, the piping 1202 forms a closed loop and has an inlet for receiving the pressurized gas. A valve 1201 has been provided to control the flow of the pressurized gas into the piping 1202. Also, the valve 1201 allows the source of the pressurized gas (such as a compressor or a pump) to switch off once a predetermined quantity of the pressurized gas has been delivered to the piping 1202. Additionally, the valve 1201 will prevent any backflow of the pressurized gas from the piping 1202, once the source of the pressurized gas has been switched off.

Also, the piping 1202 has insulation 1203 provided along the piping 1202. The insulation 1203 is provided to minimize heat loss/gain across the piping 1202 and the system 1200. The insulation 1203 is envisaged to be suited for heating applications (such as glass wool). Also, the piping 1202 and all connections in constituents of the system 1200 are designed to be leakproof to minimize the requirement of top-up of the pressurized gas.

Additionally, one or more velocity and pressure enhancers 1208 are connected along the piping 1202. The one or more velocity and pressure enhancers 1208 may include, for example, (centrifugal or positive displacement) compressors, inline fans and blowers etc. The one or more velocity and pressure enhancers 1208 may be connected at various locations along the piping 1202. Additionally, it is envisaged here that to ensure better control over functioning of the system 1200, in start stop and variable load operations, that the one or more velocity and pressure enhancers 1208 be operated using variable frequency and/or variable speed drives to control the mass flow rate based on the above requirements of operations.

Also, a heat exchanger 1206 is connected along the piping 1202. In various embodiments, the heat exchanger 1206 may be, but not limited to, a shell and tube type, pipe in pipe, coil type, or fin tube type heat exchanger. In such embodiments, the heat exchanger 1206 would deploy indirect heating. However, in the given illustrations, just for clarity of discussion, the heat exchanger 1206 has been illustrated to be immersed coil type, where a coil 1207 has been immersed into the piping 1202 and is configured to transfer thermal energy to a process application. A person skilled in the art would appreciate that many variations to design of the heat exchanger 1206 (for both direct or indirect heating) are possible, without departing from the scope of the invention. Hence, the illustrations should not be construed as limiting.

In various other embodiments, such as for heating of solids and/or semi-solids, the heat exchanger 1206 may be direct contact type heat exchanger 1206. This way the heat exchanger 1206 is configured to deliver the thermal energy to a process application. The process application may include for example heating of process fluids, drying, curing and phase change of solids and semi-solids and water treatment etc. In that manner, the system 1200 may be modified to include additional equipment that would be specific to a certain process application. For example, in water treatment, solid removal mechanisms, filters, oil separators may need to be deployed in the system 1200. In other scenarios, the system 1200 may be modified to include a turbomachinery assembly for Combined Heating and Power (CHP) applications.

The piping 1202 is configured to receive the pressurized gas via the inlet and recirculate the pressurized gas inside the closed loop. The one or more velocity and pressure enhancers 1208 are configured to maintain mass flow, velocity and thermal energy of the pressurized gas, inside the closed loop. The flow, the velocity and the thermal energy would be maintained at their respective predetermined values. It is envisaged that, the one or more velocity and pressure enhancers 1208 will have at least one velocity and pressure enhancer 1208 downstream of the heat exchanger 1206, to compensate for the loss of thermal energy in the heat exchanger 1206 and pressure losses along the piping 1202. This would result in continuation of the recirculation of the pressurized gas in the closed loop.

Additionally, a nozzle 1204 may be provided upstream of the heat exchanger 1206. The nozzle 1204 is configured to enhance a velocity of the pressurized gas in the piping 1202, just before the pressurized gas enters the heat exchanger 1206. In that manner, the nozzle 1204 may include any one or more of convergent type nozzles, divergent type nozzles and convergent-divergent type nozzles.

The system 1200 also includes control and instrumentation for monitoring and control of the functioning of the system 1200. In various embodiments, a plurality of pressure sensors 1210 may be provided at a number of locations along the piping 1202. A plurality of temperature sensors 1212 may also be provided at a number of locations along the piping 1202, for monitoring of the temperature of the pressurized gas. The temperature sensors 1212 have been provided across the heat exchanger 1206 for monitoring and controlling respective inlet and outlet temperatures of both the working fluid and the process application. A plurality of velocity sensors 1214 may also be located at a number of locations for monitoring of the velocity and the mass flow rate of the pressurized gas. Typical locations for locating velocity sensors 1214 would be just upstream of the heat exchanger 1206, although this is not binding.

The system 1200 is also envisaged to include a central control system (for example DCS or SCADA) that would receive signals from the plurality of sensors discussed above and also process side sensors and use control logic to control field devices such as valves, actuators, variable speed and variable frequency drives. In addition, there may be provided additional equipment, depending upon specific applications, that may be used to enhance performance and efficiency of the system 1200.

FIG. 1B illustrates the system 1200 for delivery of thermal energy, in accordance with another embodiment of the present invention. As illustrated in FIG. 1B, a heat source 1216 has been provided along the piping 1202. The heat source 1216 is configured to increase a temperature of the pressurized gas. In one embodiment of the invention, the heat source 1216 is an electrically operated heat source, having a heating coil 1217. The heat source 1216 in that manner may be powered by, but not limited to, DC, single phase AC or polyphase AC power via a high frequency power source etc. Additionally, any other heat source 1216 deriving energy from fossil fuels, bio fuels etc. can also be envisaged as a medium of the heat source 1216. There is also provided another nozzle 1204 upstream of the heat source 1216.

Additionally, a plurality of flow control valves 1205 may be provided along the piping 1202 configured to isolate a section of the piping 1202, the isolated section having a lower pressure as compared to rest of the piping 1202. The plurality of flow control valves 1205 will help in control of the delivery of thermal energy by controlling the mass flow across the heat exchanger 1206, in start stop as well as during variations in heat demand from the application end.

FIG. 10 illustrates the system 1200 for delivery of thermal energy, in accordance with yet another embodiment of the present invention. As illustrated in FIG. 10, the piping 1202 is envisaged to have variable cross-sectional area along the system 1200. For example, at certain locations (such as upstream of the heat exchanger 1206, the one or more velocity and pressure enhancers 1208 and the nozzle 1204), the piping 1202 may have a gradually decreasing cross-sectional area configured for increasing the velocity of the pressurized gas, inside the closed loop and at certain locations (such as downstream of the heat exchanger 1206, the one or more velocity and pressure enhancers 1208 and the nozzle 1204), the piping 1202 may have gradually increasing cross-sectional area inside the closed loop.

FIG. 1D illustrates the system 1200 for delivery of thermal energy, in accordance with yet another embodiment of the present invention. As shown in FIG. 10, the velocity and pressure enhancers 1208 have been provided at more than one location along the piping 1202. The actual number of the velocity and pressure enhancers 1208 would vary according to specific applications.

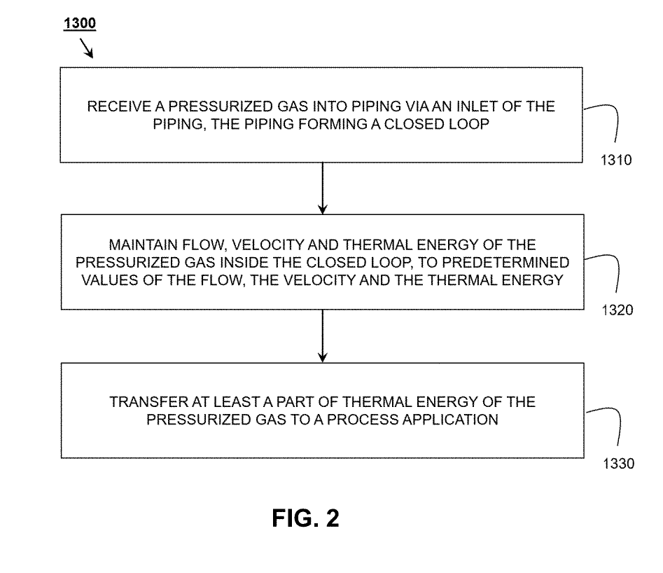

FIG. 2 illustrates a method 1300 for delivery of thermal energy, in accordance with an embodiment of the present invention. At step 1310, the pressurized gas is received into the piping 1202 via an inlet of the piping 1202. In that manner a predetermined quantity of the pressurized gas is received in the piping 1202. The pressurized gas may be supplied from the atmosphere if the pressurized gas is air, however, in cases of gases like CO₂, N₂, and O₂ etc., the pressurized gas would need to be supplied from storage tanks. The storage tanks in turn may be configured to store the gases at any of the ambient or above ambient pressures. In applications where, low to medium temperatures of the working fluid are preferred for delivery of thermal energy, the pressurized gas loading can be carried out using suitable compressors or if part of the working fluid is in liquid form whereupon during vaporization the need for extra heat can be met with a combination of compressor heat and the heat source 1216.

Once the predetermined quantity of the pressurized gas is admitted into the closed loop, preferably via the valve 1201, the addition of the pressurized gas will stop. The received pressurized gas will act as a working fluid for the method 1300. The pressurized gas is in the closed loop, where volume of the closed loop is constant. The quantity of the pressurized gas may be adjusted based on the requirements of density, pressure, temperature and velocity of the working fluid. The makeup of the pressurized gas may be required only in special cases, such as accidental leakages and changes in process requirements. The pressurized gas would be recirculated inside the piping 1202, using the equipment installed along the piping 1202. The recirculation has been discussed in method steps that follow. The insulation 1203 would prevent any heat transfer between the atmosphere and the closed loop system.

At step 1320, the one or more velocity and pressure enhancers 1208 maintain the flow, the velocity and the thermal energy of the pressurized gas inside the closed loop, to predetermined values of the flow, the velocity and the thermal energy. In that manner, the one or more velocity and pressure enhancers 1208 would compensate for thermal energy transferred in the heat exchanger 1206. In other words, the heat lost by the working fluid inside the heat exchanger 1206, would be compensated for, due to compression of the working fluid in the one or more velocity and pressure enhancers 1208. While compression would result in generation of thermal energy in the one or more velocity and pressure enhancers 1208, the flow and velocities imparted to the working fluid will result in very high heat transfer rates to the process application, inside the heat exchanger 1206.

For that purpose, any number of velocity and pressure enhancers 1208 may be deployed upstream and downstream of the heat exchanger 1206. For the embodiments involving higher level of energy (in terms of temperature) required compared to the capacities of the one or more velocity and pressure enhancers 1208, the heat source 1216 would be providing the additional concentrated thermal energy to balance the demands of the process application. In that manner heating by the heat source 1216 will provide sufficient thermal energy in applications where the thermal energy generated by the one or more velocity and pressure enhancers 1208 is insufficient for meeting the demands of the application. However, respective locations of the one or more velocity and pressure enhancers 1208 and the heat source 1216 may be interchanged.

The instrumentation provided along the piping 1202 will allow the control system to monitor parameters such as temperatures, velocity, pressure, density and mass flow rate of the working fluid and the heat transfer rates. However, wherever there are deviations found from intended values of these parameters, necessary adjustments would need to be made. For example, in case of drop in temperature below a set point, the heat source 1216 would be activated by the control system. For variations in pressure, the respective speeds of the drives driving the one or more velocity and pressure enhancers 1208 may be varied. In case of density variations, the valve 1201 may be actuated to adjust the mass of the pressurized gas inside the closed loop. In that manner, the mass flow and the velocity of the pressurized gas, in the closed loop, may be controlled with the aid of the one or more velocity and pressure enhancers 1208, the heat source 1216, the valve 1201 and other control equipment.

The nozzle 1204 would be used to achieve even higher velocities of the pressurized gas as the working fluid. However, to achieve a predetermined velocity of the working fluid, a predetermined clearance may be provided between the nozzle 1204 and the heat exchanger 1206. Higher velocities achieved due to the nozzle 1204 will even further enhance the heat transfer rates in the heat exchanger 1206.

At step 1330, at least a part of the thermal energy of the pressurized gas would be transferred to a process application, using the heat exchanger 1206. The part of the thermal energy transferred may be used in several ways depending upon specific design of the process applications. There may additional method steps that may result due to additional equipment introduced for a certain process application.

Some of exemplary process applications have been discussed below, to which the system 1200 and the method 1300 would be applicable. In that manner, the system 1200 and the method 1300 have been extended to include the additional equipment that have been discussed about in the earlier discussion.

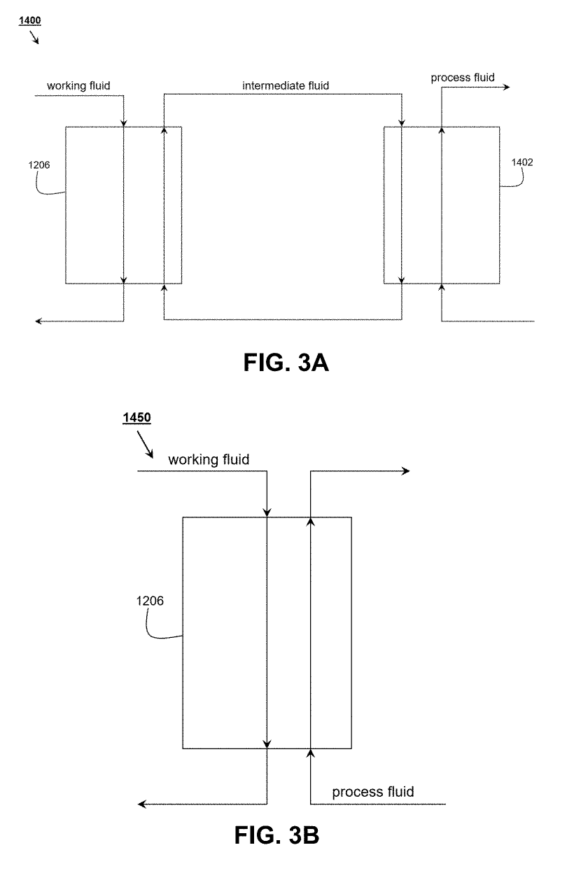

FIG. 3A illustrates an application of the system 1200 for heating of a process fluid, in accordance with an embodiment 1400 of the present invention. As illustrated in FIG. 3A, the working fluid (or the pressurized gas) is being used to heat an intermediate fluid in the heat exchanger 1206. The intermediate fluid may be, for example, Therminol® 55. However, in various other applications, the intermediate fluid may also be pressurized steam, hot water, hot air and other hot gases. The intermediate fluid in turn is being used to heat the process fluid in a process heat exchanger 1402. The process fluid in this case may be, for example, water and ethanol mixture. In that manner, the process application may involve separation of water from ethanol.

FIG. 3B illustrates an application of the system 1200 for heating of a process fluid, in accordance with another embodiment 1450 of the present invention. In the scenario of FIG. 3B, the working fluid is being used to heat the process fluid, in the heat exchanger 1206, without any mediation of the intermediate fluid. This implementation leads to higher efficiencies by eliminating the step of heating the intermediate fluid and one of the two heat exchangers discussed above.

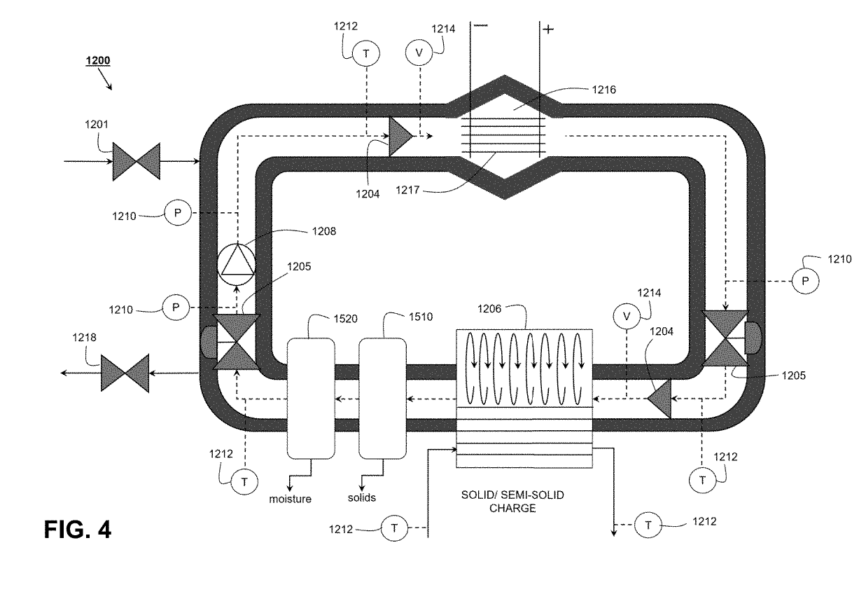

FIG. 4 illustrates an application of the system 1200 for direct heating of process substances, in accordance with an embodiment of the present invention. The heat exchanger 1206 here is configured to receive a process substance (such as a process solid or a semi-solid) for direct heating application. Direct heating applications, for example, may include kilns, dryers (including spray dryers, batch dryers and continuous dryers), furnaces and ovens. However, in direct heating application, it is possible for the working fluid to pick up moisture, dust and ash content etc. from the process substance. Therefore, an inline filtering system 1510, along with solid removal arrangements, has been installed along the piping 1202 and downstream of the heat exchanger 1206. The inline filtering system 1510, may include, but is not limited to, one or more filters (such as cyclones) arranged in series and/or parallel and oil/water separators etc. Downstream of the inline filtering system 1510, a condenser 1520 is installed along the piping 1202. The condenser 1520 is configured to separate moisture from the working fluid, that the working fluid would have picked up from the process substance.

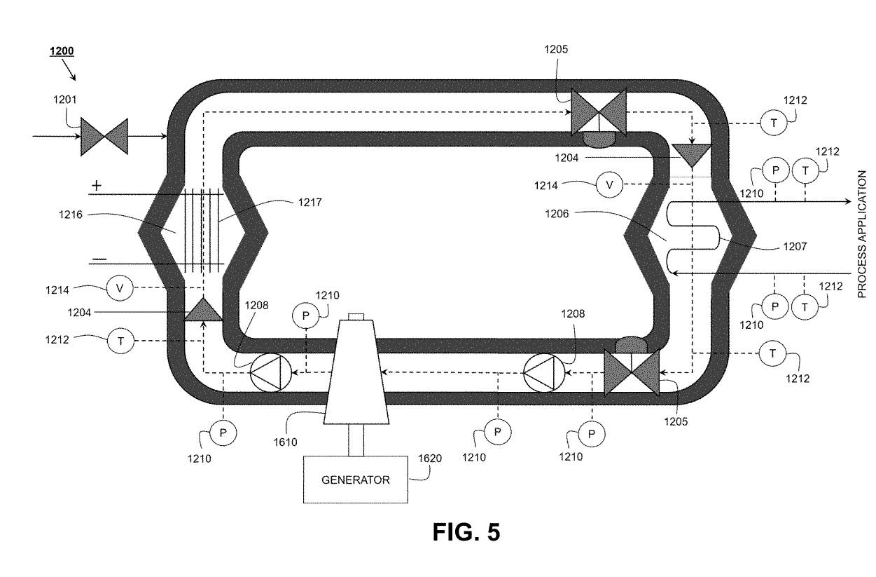

FIG. 5 illustrates an application of the system 1200 for CHP application, in accordance with an embodiment of the present invention. In that manner the system 1200 further includes a turbomachinery assembly 1610 connected along the piping 1202. In various embodiments, the turbomachinery assembly 1610 may include turbines or any other turbomachinery. Further connected to the turbomachinery assembly 1610 is a generator 1620 configured for generating electrical power. The electrical power may then be used for various applications within the system 1200 or may be fed to a grid.

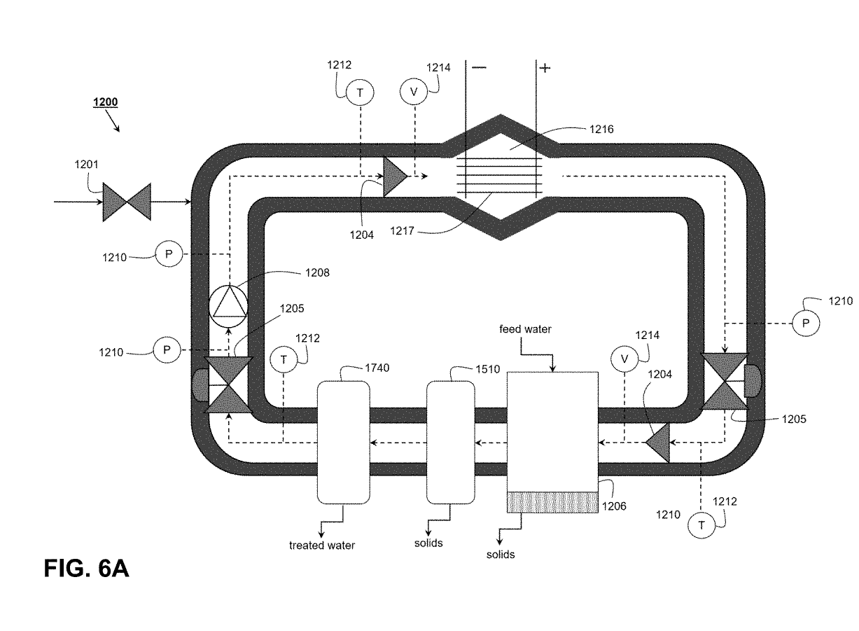

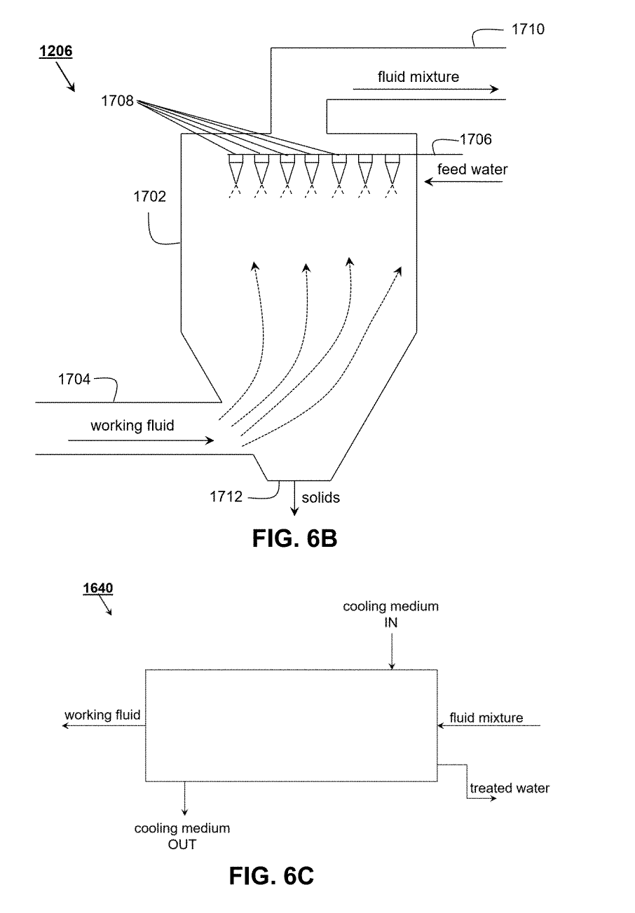

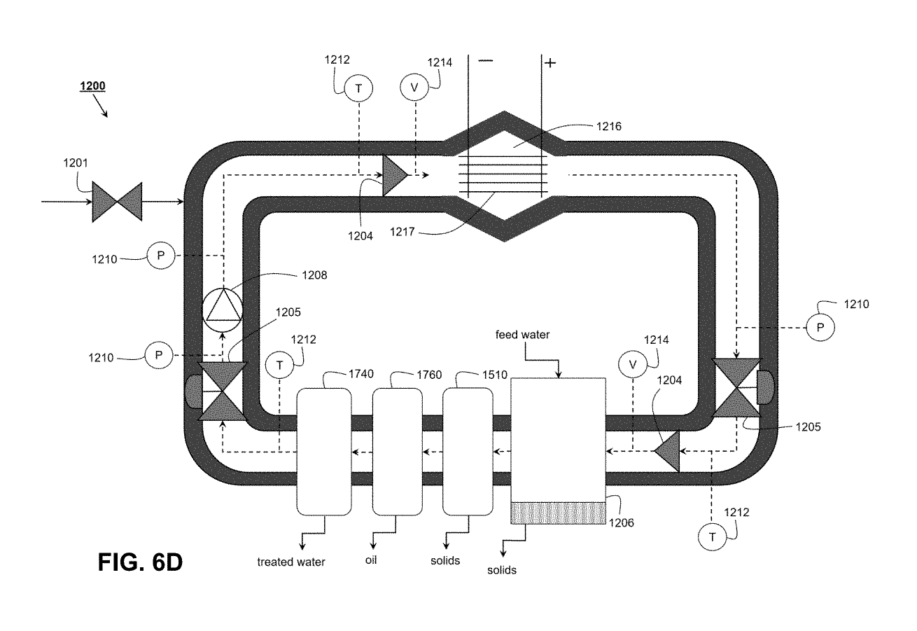

FIG. 6A illustrates an application of the system 1200 for water treatment, in accordance with an embodiment of the present invention. In this scenario the heat exchanger 1206 is configured to receive feed water from an external source and vaporize the feed water, separating out solids and other contaminants from the feed water. For effluent water treatment applications, the feed water may be effluent water from an industrial process. For desalination applications, the feed water may be sea water or may be sourced from some other saline water source.

FIG. 6B illustrates the heat exchanger 1206, for water treatment, in accordance with an embodiment of the present invention. The heat exchanger 1206, in this embodiment, is envisaged to be a direct contact type heat exchanger and includes a vessel 1702. A working fluid inlet 1704 is configured to receive the working fluid into the vessel 1702 through one or more flow directing nozzles and a feed water inlet 1706 is configured to receive feed water into the heat exchanger 1206. In various embodiments, the feed water inlet 1706 may also be provided with a plurality of spray nozzles 1708 configured to atomize and spray the feed water into the vessel 1702. The sprayed feed water comes in contact with the working fluid inside the vessel 1702 and vaporizes, thereby separating solids and other contaminants from the feed water. The vaporized feed water and the working fluid together form a fluid mixture. The fluid mixture may also contain additional solids that could not be separated during vaporization of the feed water. The solids and the other contaminants that were separated, may be removed from the vessel 1702, through a solid outlet 1712. A fluid outlet 1710 is configured to discharge the fluid mixture into the piping 1202.

Since the heat exchanger 1206 of FIG. 6A is also a direct contact type heat exchanger, the inline filtering system 1510 has been provided along the piping 1202, downstream of the heat exchanger 1206. Any solids left in the fluid mixture leaving the heat exchanger 1206 may be separated out by the inline filtering system 1510. Further, downstream of the inline filtering system 1510, there is provided a condenser 1740 connected along the piping 1202.

FIG. 6C illustrates the condenser 1740 in accordance with an embodiment of the present invention. The condenser 1740 is configured to receive the fluid mixture and separate out the working fluid and treated water from the fluid mixture. The condenser 1740 may achieve condensation of the treated water using a cooling medium and the method for removal of the treated water from the working fluid. The cooling medium could be ambient air, water or any other low temperature fluid suitable for the application.

FIG. 6D illustrates an application of the system 1200 for water treatment, in accordance with another embodiment of the present invention. FIG. 6D illustrates a scenario where the feed water is envisaged to include oil content. The oil in the feed water may tend to vaporize along with water, in the heat exchanger 1206. As a result, the oil may not be separated from the feed water inside of the heat exchanger 1206. Therefore, an oil separator 1760 has been provided downstream of the heat exchanger 1206 and upstream of the condenser 1740. The oil separator is configured to separate oil content from the fluid mixture leaving the heat exchanger 1206.

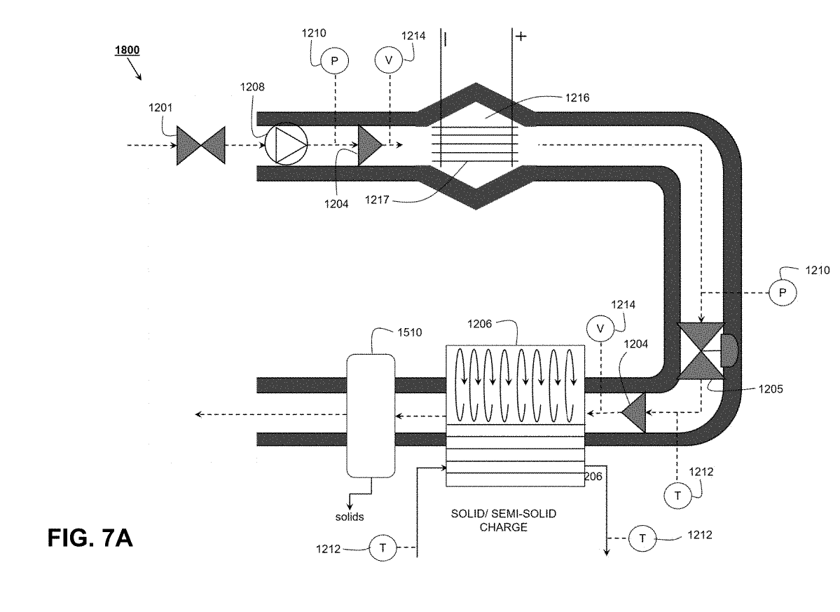

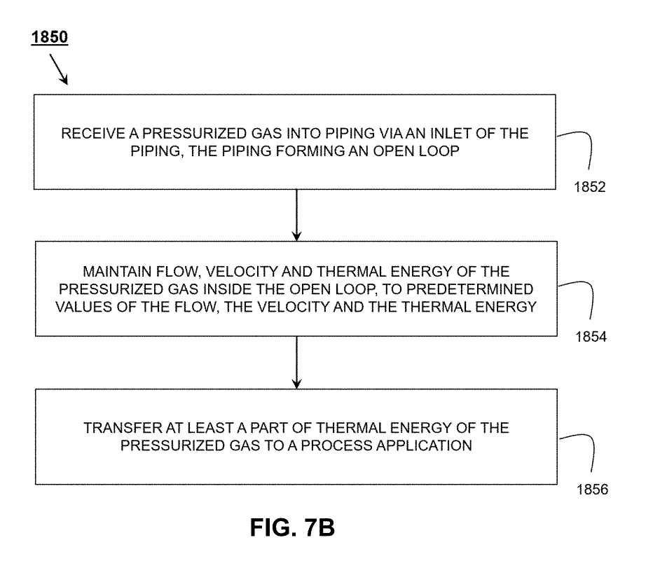

FIG. 7A illustrates a system 1800 for delivery of thermal energy, employing an open loop cycle, in accordance with an embodiment of the present invention. In this scenario, the piping 1202 forms an open loop. The piping is configured to receive a pressurized gas at high velocities, from a source such as very high-speed turbo-blowers, high speed centrifugal blowers or compressors or high-speed fans. The one or more velocity and pressure enhancers 1208 are configured to maintain flow, velocity and thermal energy of the pressurized gas in the open loop. The high velocity pressurized gas would then act like the working fluid and would be equivalent to combusted gas in terms of thermal energy content, at any given pressure, temperature and velocity, but without needing any oxidation reactions. The heat source 1216, which in this scenario could be a tunnel furnace (or an electrically heated tunnel furnace), is configured to provide concentrated thermal energy to the pressurized gas. The heat exchanger 1206 is configured to transfer at least a part of thermal energy of the pressurized gas to a process application, which would be all high temperature applications, such as drying, curing and phase change.

FIG. 7B illustrates a method 1850 for delivery of thermal energy, employing an open loop cycle, in accordance with an embodiment of the present invention. At step 852, the pressurized gas is received into the piping 1202, via an inlet and the valve 1201. The piping 1202 forms an open loop. At step 854, the one or more velocity and pressure enhancers 1208 maintain the flow, the velocity and the thermal energy of the pressurized gas to predetermined values of the flow, the velocity and the thermal energy, inside the open loop. At step 856, at least a part of the thermal energy of the pressurized gas is transferred to a process application, through the heat exchanger 1206.

Various modifications to these embodiments are apparent to those skilled in the art from the description. The principles associated with the various embodiments described herein may be applied to other embodiments. Therefore, the description is not intended to be limited to the embodiments but is to be providing broadest scope consistent with the principles and the novel and inventive features disclosed or suggested herein. Accordingly, the invention is anticipated to hold on to all other such alternatives, modifications, and variations that fall within the scope of the present invention.

I claim:

1. A system (1200) for delivery of thermal energy, the system (1200) comprising:
piping (1202) for carrying a pressurized gas, the piping (1202) forming a closed loop and having an inlet for receiving the pressurized gas;
one or more velocity and pressure enhancers (1208) connected along the piping (1202); and
a heat exchanger (1206) connected along the piping (1202);
wherein the piping (1202) is configured to receive the pressurized gas via the inlet and recirculate the pressurized gas inside the closed loop;
wherein the one or more velocity and pressure enhancers (1208) are configured to maintain flow, velocity and thermal energy of the pressurized gas to predetermined values of the flow, the velocity and the thermal energy, inside the closed loop; and
wherein the heat exchanger (1206) is configured to transfer at least a part of the thermal energy of the pressurized gas to a process application.

2. The system (1200) as claimed in claim 1, wherein the pressurized gas includes one or more of air, CO₂, N₂ and O₂.

3. The system (1200) as claimed in claim 1, further comprising a valve (1201) configured to control flow of the pressurized gas into the piping (1202).

4. The system (1200) as claimed in claim 1, wherein the piping (1202) includes an insulation (1203) provided along the piping (1202).

5. The system (1200) as claimed in claim 1, wherein the one or more velocity and pressure enhancers (1208) are configured to be operated using variable frequency and/or variable speed drives.

6. The system (1200) as claimed in claim 1, wherein the heat exchanger (1206) is a direct contact type heat exchanger.

7. The system (1200) as claimed in claim 6, further comprising one or more of an inline filtering system (1510) and a condenser (1520) connected along the piping (1202).

8. The system (1200) as claimed in claim 1, further comprising one or more nozzles (1204) provided along the closed loop, wherein the one or more nozzles (1204) are configured to enhance the velocity of the pressurized gas in the piping (1202).

9. The system (1200) as claimed in claim 1, further comprising:
a plurality of pressure sensors (1210) configured for monitoring and control of the pressure inside the closed loop;
a plurality of temperature sensors (1212) configured for monitoring and control of the temperature of the pressurized gas;
a plurality of velocity sensors (1214) configured for monitoring of the velocity and the mass flow rate of the pressurized gas; and
a central control system connected with the plurality of pressure sensors (1210), the plurality of temperature sensors (1212) and the plurality of velocity sensors (1214).

10. The system (1200) as claimed in claim 1, further comprising a heat source (1216) provided along the piping (1202), wherein the heat source (1216) is configured to provide concentrated thermal energy to the pressurized gas.

11. The system (1200) as claimed in claim 1, further comprising a plurality of flow control valves (1205) provided along the piping (1202), wherein the plurality of flow control valves (1205) is configured to isolate a section of the piping (1202), the isolated section having a lower pressure as compared to rest of the piping (1202).

12. The system (1200) as claimed in claim 1, wherein the piping (1202) has a variable cross-section area.

13. The system (1200) as claimed in claim 1, further comprising a turbomachinery assembly (1610) with a Power Take-Off (PTO) shaft, connected along the piping (1202).

14. A heat exchanger (1206) for water treatment applications, the heat exchanger (1206) comprising:
a vessel (1702) including a working fluid inlet (1704) configured to receive a working fluid into the vessel through one or more flow directing nozzles and a feed water inlet (1706) configured to receive feed water;
a plurality of spray nozzles (1708) provided with the feed water inlet, the plurality of spray nozzles (1708) configured to atomize and spray the feed water into the vessel;
a fluid outlet (1710) configured to discharge a fluid mixture of vaporized feed water and the working fluid, formed due to vaporization of the atomized feed water on coming in contact with the working fluid; and
a solid outlet (1712) configured to remove solids separated due to vaporization of the feed water.

15. A system (1800) for delivery of thermal energy, the system (1800) comprising:
piping (1202) for carrying a pressurized gas, the piping (1202) forming an open loop and having an inlet for receiving the pressurized gas;
one or more velocity and pressure enhancers (1208) connected along the piping (1202); and
a heat exchanger (1206) connected along the piping (1202);
wherein the piping (1202) is configured to receive the pressurized gas via the inlet;
wherein the one or more velocity and pressure enhancers (1208) are configured to maintain flow, velocity and thermal energy of the pressurized gas to predetermined values of the flow, the velocity and the thermal energy, inside the open loop; and
wherein the heat exchanger (1206) is configured to transfer at least a part of the thermal energy of the pressurized gas to a process application.

16. The system (1800) as claimed in claim 15, further comprising a heat source (1216) provided along the piping (1202), wherein the heat source (1216) is configured to provide concentrated thermal energy to the pressurized gas.

17. A method (1300) for delivery of thermal energy, the method (1300) comprising steps of:
receiving (1310) a pressurized gas into piping (1202), via an inlet, the piping (1202) forming a closed loop and recirculating the pressurized gas inside the closed loop;
maintaining (1320) flow, velocity and thermal energy of the pressurized gas to predetermined values of the flow, the velocity and the thermal energy, inside the closed loop, through one or more velocity and pressure enhancers (1208); and
transferring (1330) at least a part of the thermal energy of the pressurized gas to a process application, through a heat exchanger (1206).

18. The method (1300) as claimed in claim 17, further comprising a step of providing thermal energy to the pressurized gas, through a heat source (1216).

19. The method (1300) as claimed in claim 17, further comprising a step of enhancing the velocity of the pressurized gas in the piping (1202), through one or more nozzles (1204).

20. A method (1850) for delivery of thermal energy, the method (1300) comprising steps of:
receiving (1852) a pressurized gas into piping (1202), via an inlet, the piping (1202) forming an open loop;
maintaining (1854) flow, velocity and thermal energy of the pressurized gas to predetermined values of the flow, the velocity and the thermal energy, inside the open loop, through one or more velocity and pressure enhancers (1208); and
transferring (1856) at least a part of the thermal energy of the pressurized gas to a process application, through a heat exchanger (1206).
